(19) United States
(12) Patent Application Publication
(10) Pub. No.: US 2026/0086199 A1
(43) Pub. Date: Mar. 26, 2026

(54) METHOD FOR DETECTING LOW-ALTITUDE AIR VEHICLE

(71) Applicants: Wuchang University of Technology, Wuhan City (CN); Hubei Zhouhui Automotive Technology Co., Ltd., Shiyan City (CN)

(72) Inventors: Qing AN, Wuhan City (CN); Qinzhou WEI, Shiyan City (CN); Bing FU, Shiyan City (CN); Yaqiong LI, Wuhan City (CN); Lei YAN, Wuhan City (CN); Fang LI, Wuhan City (CN); Bo WANG, Wuhan City (CN)

(21) Appl. No.: 18/891,533

(22) Filed: Sep. 20, 2024

(51) Int. Cl. G01S 7/41; G01S 13/04

(52) U.S. Cl. CPC G01S 7/41; G01S 13/04

(57) ABSTRACT

Provided is a method for detecting a low-latitude air vehicle. The method includes following steps: S1: setting up a fixed column and a movable column, and disposing a detection antenna; S2: determining whether two detection antennas on the fixed column simultaneously detect a target; and if the two detection antennas on the fixed column simultaneously detect the target, performing step S3; or if the two detection antennas on the fixed column do not simultaneously detect the target, performing no operation; S3: determining in real time whether at least one of the two detection antennas loses the detected target; and if the at least one of the two detection antennas loses the detected target, performing step S4; otherwise, adopting the two detection antennas for detection; and S4: driving a rotating shaft to make the movable column rotate; and adopting four detection antennas for detection.

### TECHNICAL FIELD

The present disclosure relates to the technical field of air vehicle detection, and in particular, to a method for detecting a low-altitude air vehicle.

### BACKGROUND

At present, an aerial flying unit is applied more widely, and has become a professional device and a living tool in various industries. This can greatly save work time and improve work efficiency. However, in some key regions such as an airport, a prison, and a government department, an air vehicle poses a security risk to these sensitive regions. Therefore, it is urgent to perform anti-passive detection of the air vehicle to detect, suppress, and intercept the air vehicle to achieve security protection in the key regions.

In low-altitude protection, the air vehicle flies at a relatively low altitude and a slow speed, and its volume is small. Therefore, the air vehicle is referred to as a typical “low, small, and slow” target. At present, the air vehicle flying at the low altitude is usually detected through a single radar antenna. However, a radar antenna detection system has a close-range blind spot, is easily affected by a space environment, and is prone to a false alarm. Therefore, there is an increasingly high requirement for accuracy of detecting the air vehicle, and a passive air vehicle detection technology becomes maturer. For example, an existing patent CN110705450A provides a device for passively detecting an air vehicle. The device includes: a plurality of omnidirectional antennas configured to scan and monitor an air vehicle in the air, where the different omnidirectional antennas correspond to different operating frequency bands; a radio frequency (RF) collection module connected to the omnidirectional antenna and configured to receive and process a wireless signal scanned by the omnidirectional antenna, and generate a corresponding time-domain signal; a data processing module connected to the RF collection module and configured to perform time-frequency transformation on the time-domain signal to obtain corresponding spectral information; and an embedded algorithm recognition module connected to the data processing module and configured to extract a spectral feature of the spectral information in real time and determine a type of the air vehicle based on the spectral feature. The detection device provided in the above embodiments of the present disclosure achieves an integrated passive air vehicle detection system, reduces a volume, and expands a frequency band range of detecting the air vehicle.

However, the above air vehicle detection method still has following disadvantages: a complex structure, a large error due to a single detection device, existence of a detection blind spot, inability to effectively detect different types of air vehicles at different altitudes adaptively, and low detection accuracy.

Therefore, in order to solve the above problems, it is necessary to design a reasonable and efficient method for detecting a low-altitude air vehicle.

### SUMMARY

An objective of the present disclosure is to provide a method for detecting a low-altitude air vehicle. The method has a simple structure and uses fixed and movable detection antennas for air vehicle detection. A plurality of detection antennas effectively reduce an error. In addition, a displacement distance of the movable detection antenna is not less than a half-power beamwidth of the detection antenna, which effectively avoids a detection blind spot, thereby effectively detecting different types of air vehicles at different altitudes with high detection accuracy.

To achieve the above objective, the present disclosure adopts following technical solutions:

A method for detecting a low-altitude air vehicle, including following steps:
S1: setting up a fixed column and a movable column, and disposing detection antennas at two ends of each of the fixed column and the movable column, where a rotating shaft is disposed on the movable column;
S2: determining whether the two detection antennas on the fixed column simultaneously detect a target; and if the two detection antennas on the fixed column simultaneously detect the target, performing step S3; or if the two detection antennas on the fixed column do not simultaneously detect the target, performing no operation;
S3: determining in real time whether at least one of the two detection antennas on the fixed column loses the detected target; and if the at least one of the two detection antennas on the fixed column loses the detected target, performing step S4; otherwise, detecting the target through the two detection antennas on the fixed column; and
S4: driving the rotating shaft to make the movable column rotate, such that a displacement of an end portion of the movable column is not less than a half-power beamwidth of the detection antenna; and detecting the target through the four detection antennas on the fixed column and the movable column.

As a preferred solution of the present disclosure, when the step S3 is performed, that is, when the target is detected through the two detection antennas on the fixed column, step S5 is performed; and
when the step S4 is performed, that is, when the target is detected through the four detection antennas on the fixed column and the movable column, the step S5 is performed, where the step S5 is as follows:
S5: obtaining a detection signal of the detection antenna within predetermined time, and calculating information of the detected target.

As a preferred solution of the present disclosure, the fixed column and the movable column have a same length; and when the movable column is not rotating, the fixed column and the movable column are arranged in parallel, and a distance between the fixed column and the movable column is equal to the length of the fixed column.

As a preferred solution of the present disclosure, the movable column is provided with a sliding groove for facilitating sliding of the rotating shaft, and an extension direction of the sliding groove is the same as an extension direction of the movable column; and
when the step S4 is performed, displacements of two end portions of the movable column each are not less than the half-power beamwidth of the detection antenna.

As a preferred solution of the present disclosure, the sliding groove is provided with a plurality of bayonets for conveniently fixing the rotating shaft, and a distance between any two adjacent bayonets is the same.

As a preferred solution of the present disclosure, the step S4 specifically includes following substeps:
S41: driving the rotating shaft to make the movable column rotate, such that the displacement of the end portion of the movable column is not less than the half-power beamwidth of the detection antenna; and
S42: determining whether the two detection antennas on the movable column simultaneously detect the target; and if the two detection antennas on the movable column simultaneously detect the target, detecting the target through the four detection antennas on the fixed column and the movable column; or if the two detection antennas on the movable column do not simultaneously detect the target, returning to the step S41 and continuously rotating the movable column.

As a preferred solution of the present disclosure, a total of four end portion regions are disposed at the two ends of the fixed column and the two ends of the movable column; there is at least one detection antenna in each of the end portion regions; and a plurality of detection antennas in one end portion region have different detection frequencies, and quantities of detection antennas in the four end portion regions are the same and one-to-one correspond with frequencies.

As a preferred solution of the present disclosure, when the steps S2 to S4 are performed, the detection antennas detecting the target have a same frequency.

The method for detecting a low-altitude air vehicle in the present disclosure achieves following beneficial effects:

A simple structure is achieved, and fixed and movable detection antennas are used for air vehicle detection. A plurality of detection antennas effectively reduce an error. In addition, a displacement distance of the movable detection antenna is not less than a half-power beamwidth of the detection antenna, which effectively avoids a detection blind spot, thereby effectively detecting different types of air vehicles at different altitudes with high detection accuracy.

### BRIEF DESCRIPTION OF THE DRAWINGS

To describe the technical solutions in the embodiments of the present disclosure more clearly, the accompanying drawings required for describing the embodiments are briefly described below. Apparently, the accompanying drawings in the following description show merely some embodiments of the present disclosure, and those of ordinary skill in the art may still derive other accompanying drawings from these accompanying drawings without creative efforts.

FIG. 1 is a schematic diagram of a preparation process of a method for detecting a low-altitude air vehicle according to an embodiment of the present disclosure.

### DETAILED DESCRIPTION OF THE EMBODIMENTS

The following describes the technical solutions in the embodiments of the present disclosure clearly and completely with reference to the accompanying drawings in the embodiments of the present disclosure.

In the following description, terms such as “first” and “second” are merely intended for the purpose of description, and should not be construed as indicating or implying relative importance. The following description provides a plurality of embodiments of the present disclosure, and different embodiments can be replaced or combined. Therefore, the present disclosure can also be considered to include all possible combinations of the same and/or different embodiments described. Therefore, if one embodiment includes features A, B, and C, and another embodiment includes features B and D, the present disclosure should also be considered to include embodiments containing one or more other possible combinations of A, B, C, and D, although such embodiments may not be explicitly described in the following content.

The following description provides examples and does not limit the scope, applicability, or example set forth in the claims. Changes can be made to a function and an arrangement of a described element without departing from the scope of the present disclosure. In various examples, various processes or components may be omitted, replaced, or added appropriately. For example, the described method can be executed in an order different from the described order, and various steps can be added, omitted, or combined. In addition, features described about some examples can be combined into other examples.

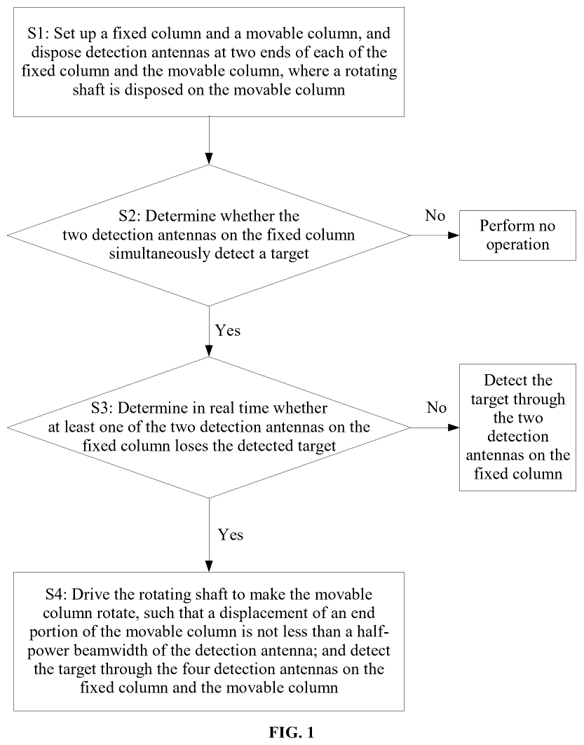

Embodiment 1: Referring to FIG. 1, a method for detecting a low-altitude air vehicle includes following steps:
S1: Set up a fixed column and a movable column, and dispose detection antennas at two ends of each of the fixed column and the movable column, where a rotating shaft is disposed on the movable column.
S2: Determine whether the two detection antennas on the fixed column simultaneously detect a target; and if the two detection antennas on the fixed column simultaneously detect the target, perform step S3; or if the two detection antennas on the fixed column do not simultaneously detect the target, perform no operation.
S3: Determine in real time whether at least one of the two detection antennas on the fixed column loses the detected target; and if the at least one of the two detection antennas on the fixed column loses the detected target, perform step S4; otherwise, detect the target through the two detection antennas on the fixed column.
S4: Drive the rotating shaft to make the movable column rotate, such that a displacement of an end portion of the movable column is not less than a half-power beamwidth of the detection antenna; and detect the target through the four detection antennas on the fixed column and the movable column.

In the present disclosure, when the step S3 is performed, that is, when the target is detected through the two detection antennas on the fixed column, step S5 is performed.

When the step S4 is performed, that is, when the target is detected through the four detection antennas on the fixed column and the movable column, the step S5 is performed.

The present disclosure further includes the step S5: obtaining a detection signal of the detection antenna within predetermined time, and calculating information of the detected target. In the present disclosure, the fixed column and the movable column have a same length. When the movable column is not rotating, the fixed column and the movable column are arranged in parallel, and a distance between the fixed column and the movable column is equal to the length of the fixed column.

Further, the step S4 specifically includes following substeps:
S41: Drive the rotating shaft to make the movable column rotate, such that the displacement of the end portion of the movable column is not less than the half-power beamwidth of the detection antenna.
S42: Determine whether the two detection antennas on the movable column simultaneously detect the target; and if the two detection antennas on the movable column simultaneously detect the target, detect the target through the four detection antennas on the fixed column and the movable column; or if the two detection antennas on the movable column do not simultaneously detect the target, return to the step S41 and continuously rotate the movable column.

The method for detecting a low-altitude air vehicle in the present disclosure has a simple structure and uses fixed and movable detection antennas for air vehicle detection. A plurality of detection antennas effectively reduce an error. In addition, a displacement distance of the movable detection antenna is not less than a half-power beamwidth of the detection antenna, which effectively avoids a detection blind spot, thereby effectively detecting different types of air vehicles at different altitudes with high detection accuracy.

Embodiment 2: Still referring to FIG. 1, on a basis of Embodiment 1, the present disclosure provides a method for detecting a low-altitude air vehicle.

The movable column is provided with a sliding groove for facilitating sliding of the rotating shaft, and an extension direction of the sliding groove is the same as an extension direction of the movable column.

When the step S4 is performed, displacements of two end portions of the movable column each are not less than the half-power beamwidth of the detection antenna.

Moreover, the sliding groove is provided with a plurality of bayonets for conveniently fixing the rotating shaft, and a distance between any two adjacent bayonets is the same.

The rotating shaft is provided with a rotating motor and a slider for carrying the rotating motor. The slider is provided with a telescopic rod and a telescopic motor for driving the telescopic rod. The telescopic rod is arranged parallel to the fixed column. When the telescopic motor works, the rotating shaft is driven to slide inside the sliding groove. A width of the sliding groove is slightly less than an outer diameter of the rotating shaft, allowing the rotating shaft to have an interference fit inside the sliding groove. After the two ends of the movable column are fixed, the telescopic motor works to drive the rotating shaft to move from one bayonet to another bayonet to change displacements of the detection antennas at the two ends of the movable column.

For example, five bayonets are provided to equally divide the movable column into sixth unit lengths. When the rotating shaft is located at a third bayonet, the rotating shaft is located in the middle of the movable column, and the displacements of the detection antennas at the two ends of the movable column are the same. When the rotating shaft is located at a second or fourth bayonet, a ratio of the displacements of the detection antennas at the two ends of the movable column is 1:2. When the rotating shaft is located at a first or fifth checkpoint, the ratio of the displacements of the detection antennas at the two ends of the movable column is 1:5. A detection blind spot can be further avoided by displacing two detection antennas with different displacement ratios.

Embodiment 3: Still referring to FIG. 1, on a basis of any one of Embodiment 1 and Embodiment 2, the present disclosure provides a method for detecting a low-altitude air vehicle. A total of four end portion regions are disposed at the two ends of the fixed column and the two ends of the movable column. There is at least one detection antenna in each of the end portion regions. A plurality of detection antennas in one end portion region have different detection frequencies, and quantities of detection antennas in the four end portion regions are the same and one-to-one correspond with frequencies.

That is, the four end portion regions each are provided with a detection antenna for each frequency band.

When the steps S2 to S4 are performed, the detection antennas detecting the target have a same frequency.

That is, when the step S2 is performed, if two detection antennas with a frequency of 50 MHz on the fixed column detect the target, in the subsequent steps S3 and S4, a detection antenna with the frequency of 50 MHz is used to detect the target.

The method for detecting a low-altitude air vehicle in the present disclosure has a simple structure and uses fixed and movable detection antennas for air vehicle detection. A plurality of detection antennas effectively reduce an error. In addition, a displacement distance of the movable detection antenna is not less than a half-power beamwidth of the detection antenna, which effectively avoids a detection blind spot, thereby effectively detecting different types of air vehicles at different altitudes with high detection accuracy.

Described above are merely exemplary embodiments of the present disclosure, which cannot be construed as a limitation on the scope of the present disclosure. Any equivalent changes and modifications made in accordance with the teachings of the present disclosure still fall within the scope of the present disclosure. A person skilled in the art can easily think of other implementation solutions of the present disclosure after considering the specification and practicing the disclosure herein. The present disclosure is intended to cover any variations, purposes, or adaptive changes of the present disclosure. Such variations, purposes, or adaptive changes follow the general principle of the present disclosure and include common knowledge or conventional technical means in the technical field which is not disclosed in the present disclosure. The specification and embodiments are merely considered as illustrative, and the scope and spirit of the present disclosure are defined by the claims.

What is claimed is:

1. A method for detecting a low-altitude air vehicle, comprising the following steps:
S1: setting up a fixed column and a movable column, and disposing detection antennas at two ends of each of the fixed column and the movable column, wherein a rotating shaft is disposed on the movable column;
S2: determining whether the two detection antennas on the fixed column simultaneously detect a target; and if the two detection antennas on the fixed column simultaneously detect the target, performing step S3; or if the two detection antennas on the fixed column do not simultaneously detect the target, performing no operation;
S3: determining in real time whether at least one of the two detection antennas on the fixed column loses the detected target; and if the at least one of the two detection antennas on the fixed column loses the detected target, performing step S4; otherwise, detecting the target through the two detection antennas on the fixed column; and
S4: driving the rotating shaft to make the movable column rotate, such that a displacement of an end portion of the movable column is not less than a half-power beamwidth of the detection antenna; and detecting the target through the four detection antennas on the fixed column and the movable column.

2. The method for detecting a low-altitude air vehicle according to claim 1, wherein
when the step S3 is performed, that is, when the target is detected through the two detection antennas on the fixed column, step S5 is performed; and
when the step S4 is performed, that is, when the target is detected through the four detection antennas on the fixed column and the movable column, the step S5 is performed, wherein the step S5 is as follows:
S5: obtaining a detection signal of the detection antenna within predetermined time, and calculating information of the detected target.

3. The method for detecting a low-altitude air vehicle according to claim 1, wherein
the fixed column and the movable column have a same length; and when the movable column is not rotating, the fixed column and the movable column are arranged in parallel, and a distance between the fixed column and the movable column is equal to the length of the fixed column.

4. The method for detecting a low-altitude air vehicle according to claim 1, wherein the movable column is provided with a sliding groove for facilitating sliding of the rotating shaft, and an extension direction of the sliding groove is the same as an extension direction of the movable column; and
when the step S4 is performed, displacements of two end portions of the movable column each are not less than the half-power beamwidth of the detection antenna.

5. The method for detecting a low-altitude air vehicle according to claim 4, wherein
the sliding groove is provided with a plurality of bayonets for conveniently fixing the rotating shaft, and a distance between any two adjacent bayonets is the same.

6. The method for detecting a low-altitude air vehicle according to claim 1,
wherein the step S4 specifically comprises following substeps:
S41: driving the rotating shaft to make the movable column rotate, such that the displacement of the end portion of the movable column is not less than the half-power beamwidth of the detection antenna; and
S42: determining whether the two detection antennas on the movable column simultaneously detect the target; and if the two detection antennas on the movable column simultaneously detect the target, detecting the target through the four detection antennas on the fixed column and the movable column; or if the two detection antennas on the movable column do not simultaneously detect the target, returning to the step S41 and continuously rotating the movable column.

7. The method for detecting a low-altitude air vehicle according to claim 1, wherein
a total of four end portion regions are disposed at the two ends of the fixed column and the two ends of the movable column; there is at least one detection antenna in each of the end portion regions; and a plurality of detection antennas in one end portion region have different detection frequencies, and quantities of detection antennas in the four end portion regions are the same and one-to-one correspond with frequencies.

8. The method for detecting a low-altitude air vehicle according to claim 7, wherein
when the steps S2 to S4 are performed, the detection antennas detecting the target have a same frequency.
